(19) United States
(12) Patent Application Publication
(10) Pub. No.: US 2026/0135301 A1
(43) Pub. Date: May 14, 2026

(54) ANTENNA SYSTEM

(71) Applicant: ALPHA NETWORKS INC., Hsinchu (TW)

(72) Inventors: KUANG-WEI LIN, Hsinchu (TW); DE-CHANG SU, Hsinchu (TW)

(73) Assignee: ALPHA NETWORKS INC., Hsinchu (TW)

(21) Appl. No.: 19/085,624

(22) Filed: Mar. 20, 2025

(30) Foreign Application Priority Data
Nov. 13, 2024 (TW) 113143581

(51) Int. Cl. H01Q 13/08; H01Q 1/02

(52) U.S. Cl. CPC H01Q 13/08; H01Q 1/02

(57) ABSTRACT

An antenna system includes a substrate, a metallic heat sink disposed above the substrate and including a body and a heat dissipation structure, and an antenna assembly. The heat dissipation structure is disposed on the body. The body has a recess portion recessed inwards from a peripheral edge of the body. The antenna assembly includes a microstrip and a radiating section. The microstrip is disposed on a surface of the substrate and is coupled to a signal source. The radiating section is connected to the body and is disposed in the recess portion. An end of the radiating section is disposed in a location adjacent to the microstrip. The radiating section is excited by the microstrip using a coupling mechanism.

### BACKGROUND OF THE INVENTION

### Technical Field

The present invention relates generally to an antenna, and more particularly to an antenna system with a heat sink for the antenna communication.

### Description of Related Art

It is known that the demand for a wireless network gradually increases. To raise a bandwidth of the wireless network and a coverage of the wireless network, more power amplifiers (PA) are necessarily used in communication products. Generally, a built-in antenna is used with a power of a wireless network product increasing and a size of the wireless network product decreasing.

However, under a confinement of a limited space, how to arrange a location in which the built-in antenna, a printed circuit board (PCB), and a metallic heat sink are disposed is quite important. Generally, if the built-in antenna is too adjacent to the metallic heat sink, a reception (RX) of a wireless signal is poor and an antenna radiation quality is reduced. In addition, considering a heat dissipation efficiency, how to maximum an area of the metallic heat sink in the limited space is also an important research topic. Therefore, how to provide an antenna system with a metallic heat sink and a built-in antenna which could coexist without affecting each other and a raised heat dissipation efficiency is a problem needed to be solved.

### BRIEF SUMMARY OF THE INVENTION

In view of the above, the primary objective of the present invention is to provide an antenna system which could maximum an area of a metallic heat sink to raise a heat dissipation efficiency and maintain a great antenna performance.

The present invention provides an antenna system including a substrate, a metallic heat sink, and an antenna assembly, wherein the metallic heat sink is disposed above the substrate and includes a body and a heat dissipation structure. The heat dissipation structure is disposed on the body. The body has a recess portion, wherein the recess portion is recessed inwards from a peripheral edge of the body. The antenna assembly includes a microstrip and a radiating section, wherein the microstrip is disposed on a surface of the substrate and is coupled to a signal source. The radiating section is connected to the body and is disposed in the recess portion. An end of the radiating section is disposed in a location adjacent to the microstrip. The radiating section is excited by the microstrip using a coupling mechanism.

With the aforementioned design, through the radiating section disposed in the recess portion, a space occupied by the antenna assembly could be greatly reduced, so that a space could be saved to be allocated to the heat dissipation structure. In this way, the heat dissipation efficiency could be greatly raised and a problem that an overall volume of a conventional antenna system is too high because of a space reserved for an antenna could be improved. In addition, through the radiating section connected to the body, the metallic heat sink could simultaneously have a heat dissipation function and an antenna communication function, so that the metallic heat sink and the antenna assembly could coexist without affecting each other.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the antenna system according to a first embodiment of the present invention;

FIG. 2 is a top view of the antenna system according to the first embodiment of the present invention;

FIG. 3 is a side view of the antenna system according to the first embodiment of the present invention;

FIG. 4 is an enlarged view of a part of the antenna system in FIG. 3;

FIG. 5 is a schematic view showing a return loss of the antenna system according to the first embodiment of the present invention;

FIG. 6 is a schematic view showing an isolation of the antenna system according to the first embodiment of the present invention;

FIG. 7 is a schematic view showing a radiation pattern of the XY plane of the antenna system operating at 2.4 GHz according to the first embodiment of the present invention;

FIG. 8 is a schematic view showing a radiation pattern of the XY plane of the antenna system operating at 5 GHz according to the first embodiment of the present invention;

FIG. 9 is a perspective view of the antenna system according to a second embodiment of the present invention;

FIG. 10 is an enlarged view of a part of the antenna system according to the second embodiment of the present invention;

FIG. 11 is a side view of the antenna system according to the second embodiment of the present invention;

FIG. 12 is a side view of the antenna system seen from another direction according to the second embodiment of the present invention;

FIG. 13 is a perspective view of the antenna system according to a third embodiment of the present invention; and

FIG. 14 is an enlarged view of a part of the antenna system in FIG. 13.

### DETAILED DESCRIPTION OF THE INVENTION

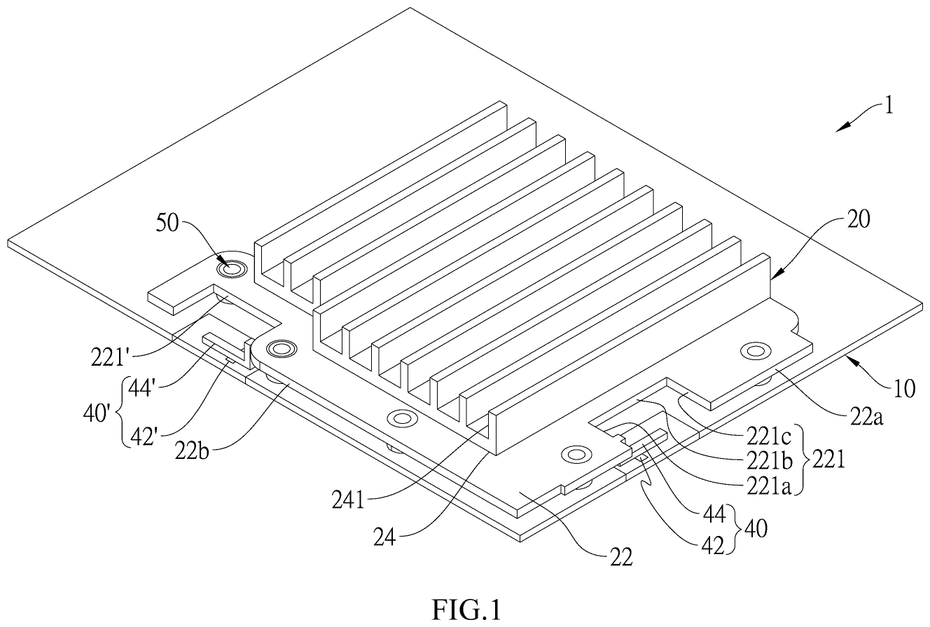

An antenna system 1 according to a first embodiment of the present invention is illustrated in FIG. 1 to FIG. 4 and includes a substrate 10, a metallic heat sink 20, and an antenna assembly 40.

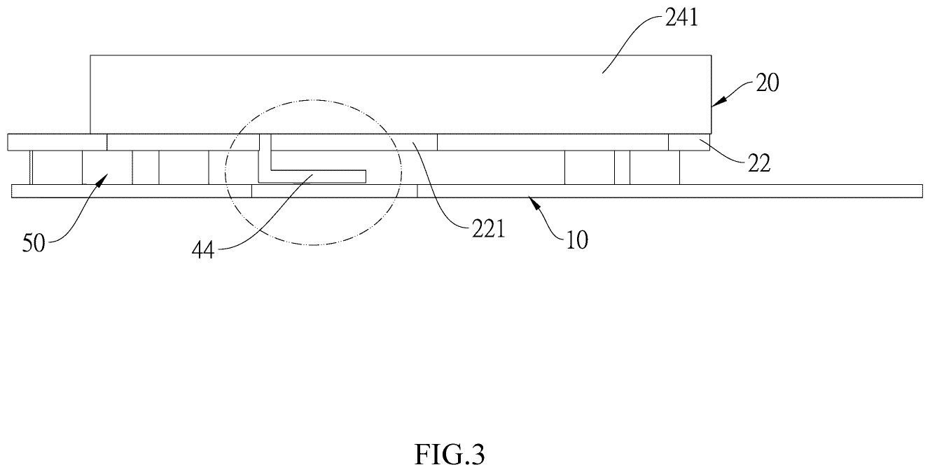

Referring to FIG. 3, the metallic heat sink 20 is disposed above the substrate 10 and is fixed on the substrate 10 through a plurality of combination pillars 50. The metallic heat sink 20 could be made of aluminum or stainless steel and includes a body 22 and a heat dissipation structure 24. The substrate 10 could be a printed circuit board (PCB) made of a fiberglass board (FR4) with a dielectric constant of 4.3. The body 22 is plate-like structure. The heat dissipation structure 24 is disposed on the body 22 and is integrated with the body 22. The heat dissipation structure 24 has a plurality of fins 241 in a parallel and spaced arrangement, thereby raising a heat dissipation efficiency.

Referring to FIG. 1 to FIG. 3, the body 22 has a recess portion 221, wherein the recess portion 221 is recessed inwards from a peripheral edge of the body 22 and has a U-shaped notch. The U-shaped notch is formed through a first lateral side 221a, a second lateral side 221b, and a third lateral side 221c subsequently connected to one another.

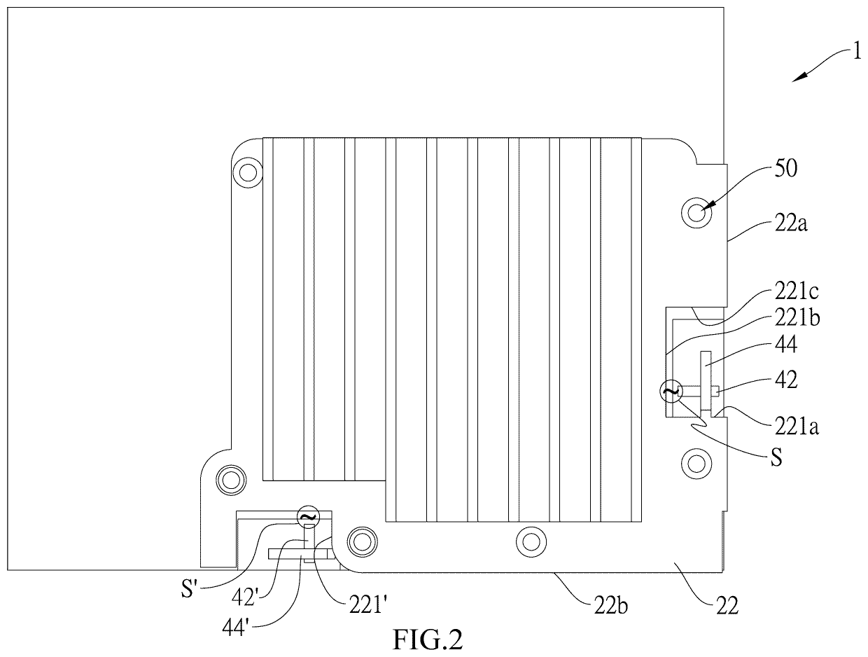

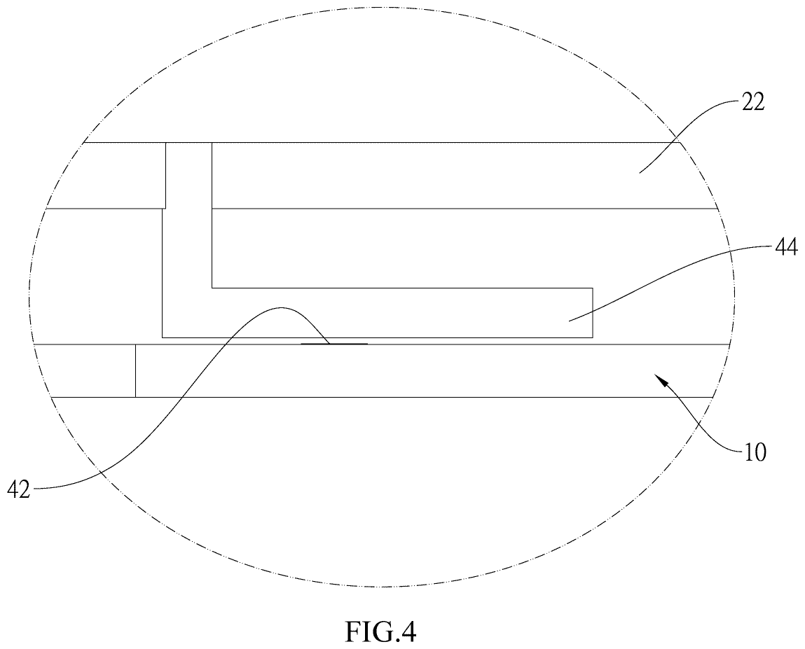

Referring to FIG. 2 to FIG. 4, the antenna assembly 40 includes a microstrip 42 and a radiating section 44, wherein the microstrip 42 is disposed on a surface of the substrate 10 and is coupled to a signal source S. The radiating section 44 is L-shaped. A distance is formed between the body 22 and the substrate 10. The radiating section 44 is connected to the body 22 and is disposed in the recess portion 221. An end of a L-shaped short side of the radiating section 44 is connected to the first lateral side 221a of the recess portion 221. Another end of the L-shaped short side of the radiating section 44 extends in a direction towards the substrate 10. An end of a L-shaped long side of the radiating section 44 is disposed in a location adjacent to the microstrip 42. A gap (as shown in FIG. 4) is formed between an end of the radiating section 44 adjacent to the microstrip 42 and the microstrip 42. The radiating section 44 is excited by the microstrip 42 using a coupling mechanism.

In the current embodiment, a length of the microstrip 42 is substantially equal to a resonant length of 6 mm with 0.25 wavelength at 5.5 GHz. A length of the radiating section 44 is substantially equal to a resonant length of 17 mm with 0.25 wavelength at 2.4 GHz. The radiating section 44 is operated in an operating frequency band of 2.4 GHz (2400 MHz˜2484 MHz). The microstrip 42 could be considered as a monopole antenna generating a high-frequency operating mode to cover an operating frequency band of a wireless local area network of 5 GHz (5150 MHz˜5875 MHz), thereby achieving a dual frequency operation. The gap is preferably from 0.2 mm to 0.5 mm, but not limited thereto.

In the current embodiment, the radiating section 44 is connected to the first lateral side 221a of the recess portion 221 as an example. In other embodiments, the radiating section 44 could be connected to the third lateral side 221c of the recess portion 221. Through the recess portion 221 being U-shaped (i.e., the recess portion 221 has an open side), the antenna assembly 40 could maintain a great performance.

More specifically, the metallic heat sink 20 and the radiating section 44 are identically made of aluminum or stainless steel. The body 22 of the metallic heat sink 20 is integrated with the radiating section 44, so that a problem that the metallic heat sink 20 is difficult to be soldered to the radiating section 44 could be solved.

In addition, in the current embodiment, the antenna system 1 further includes another antenna assembly 40′. A structure of the another antenna assembly 40′ is almost identical to a structure of the antenna assembly 40. The another antenna assembly 40′ includes another microstrip 42′ and another radiating section 44′, wherein the another microstrip 42′ is disposed on the surface of the substrate 10 and is coupled to another signal source S′. The body 22 has another recess portion 221′, wherein the another recess portion 221′ is recessed inwards from the peripheral edge of the body 22. The another radiating section 44′ is connected to the body 22 and is disposed in the another recess portion 221′. An end of the another radiating section 44′ is disposed in a location adjacent to the another microstrip 42′. The another radiating section 44′ is excited by the another microstrip 42′ using a coupling mechanism.

In addition, a location in which the antenna assembly 40 is disposed is different from a location in which the another antenna assembly 40′. The body 22 has a first side 22a and a second side 22b different from the first side 22a, wherein the first side 22a is perpendicular to the second side 22b. The recess portion 221 is located on the first side 22a. The another recess portion 221′ is located on the second side 22b. In other words, the antenna assembly 40 is disposed on the first side 22a and the another antenna assembly 40′ is disposed on the second side 22b. In this way, the great performance of the antenna assembly 40 and a great performance of the another antenna assembly 40′ could be maintained.

In the current embodiment, the antenna assembly 40 and the another antenna assembly 40′ are illustrated as an example. In other embodiments, one or more antenna assemblies could be provided upon the required demand.

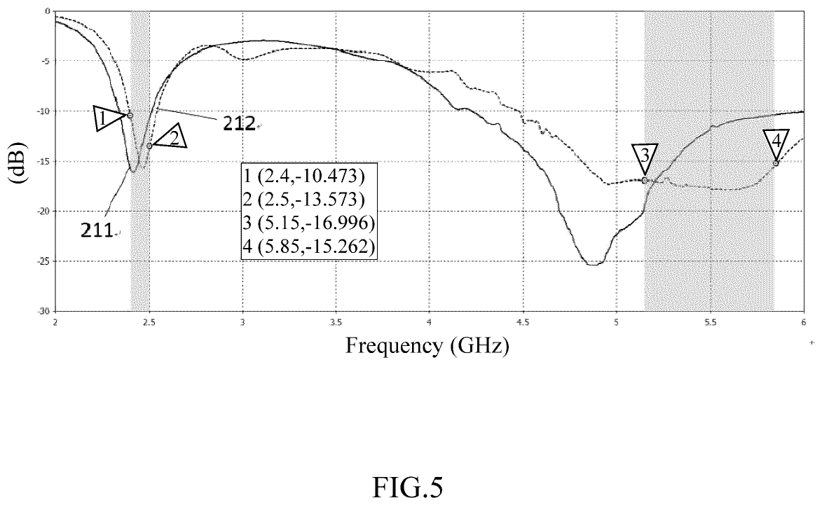

Referring to FIG. 5, a return loss of the antenna system 1 of the current embodiment is shown. A curve 211 at 2.4 GHz shows a resonant mode generated by the another radiating section 44′ and the curve 211 at 5 GHz shows a resonant mode generated by the another microstrip 42′. A return loss of the another antenna assembly 40′ in the operating frequency band of 2.4 GHz and the return loss of the another antenna assembly 40′ in the operating frequency band of 5 GHz are below −10 dB. A curve 212 at 2.4 GHz shows a resonant mode generated by the radiating section 44 and the curve 212 at 5 GHz shows a resonant mode generated by the microstrip 42. A return loss of the antenna assembly 40 at 2.4 GHz and the return loss of the antenna assembly 40 in the operating frequency band of 5 GHz are below −10 dB.

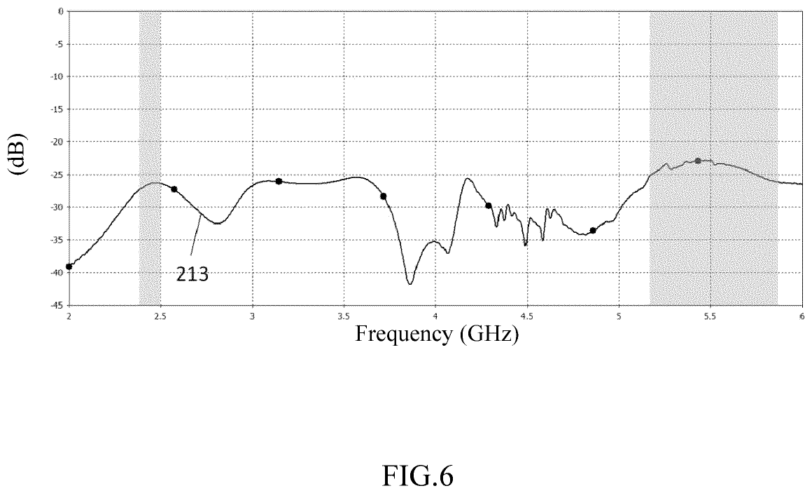

Referring to FIG. 6, an isolation of the antenna system 1 of the current embodiment is shown. A curve 213 in the operating frequency band of 2.4 GHz and the curve 213 in the operating frequency band of 5 GHz are below −20 dB, which shows a great performance of the isolation. Therefore, the antenna system 1 could maintain a great antenna performance.

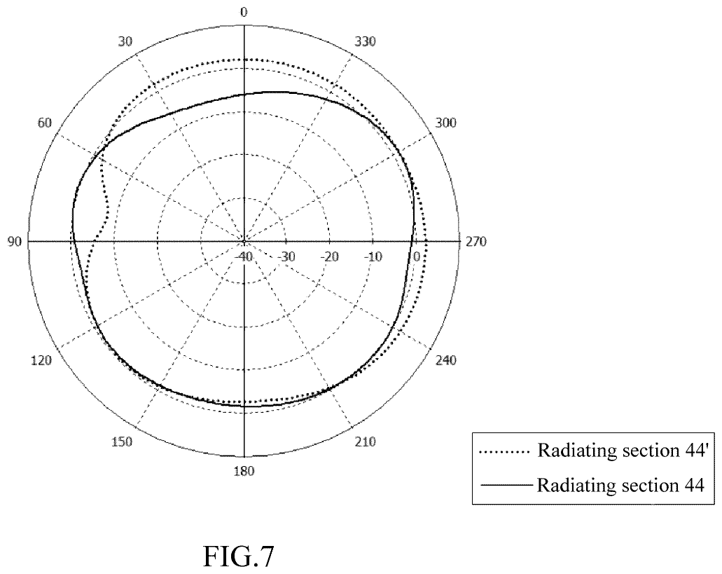

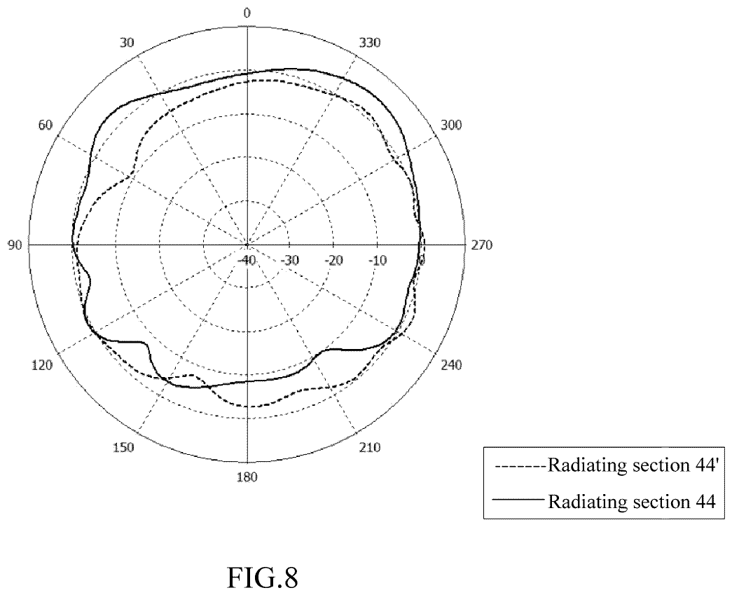

Referring to FIG. 7 and FIG. 8, a radiation pattern of the XY plane of the antenna system 1 operating at 2.4 GHz and 5 GHz is shown. The antenna system 1 is almost omni-directional in the operating frequency band of the wireless local area network (WLAN) of 2.4 GHz and 5 GHz on the XY plane and is suitable for WLAN communication products comprehensively covering the operating frequency band of the wireless local area network.

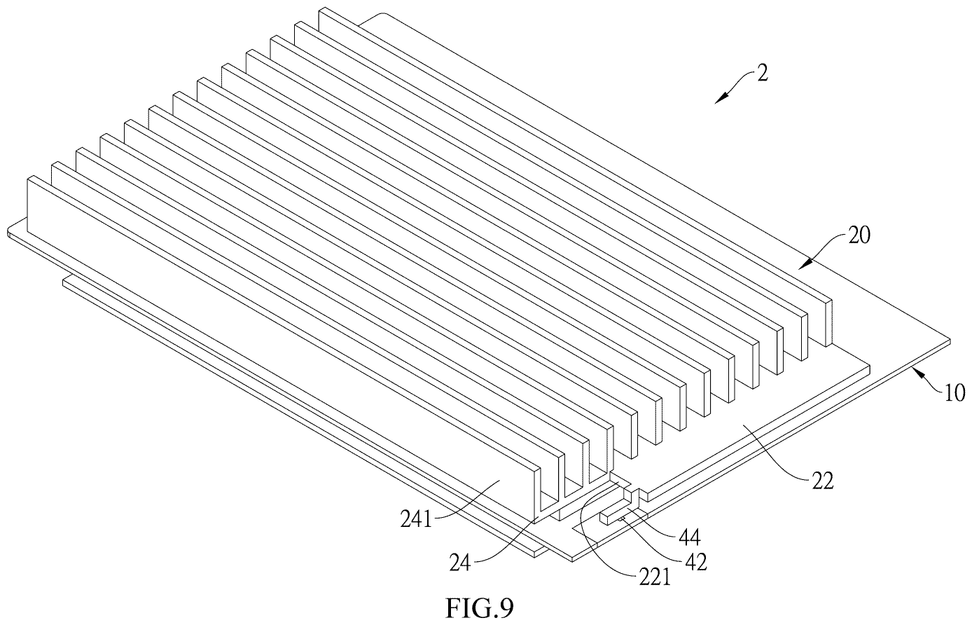

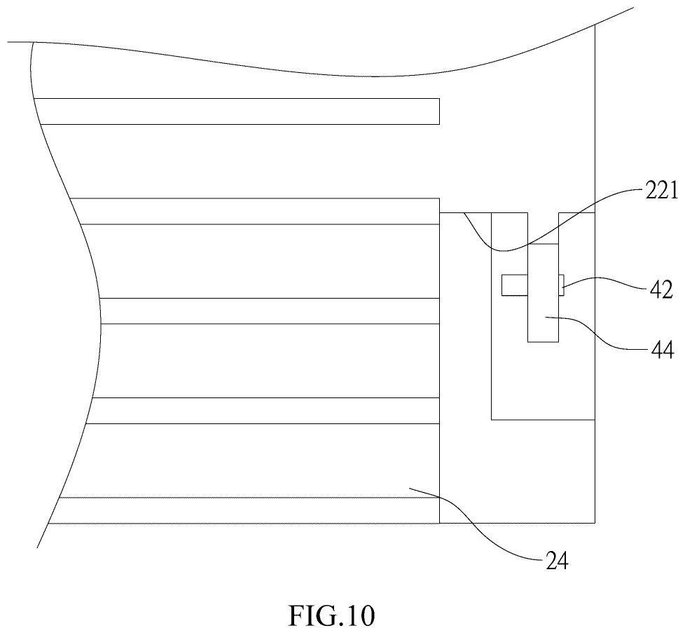

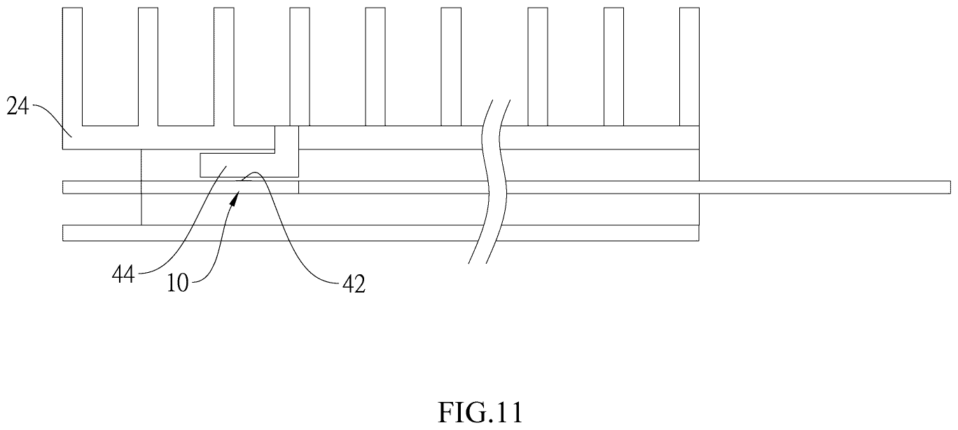

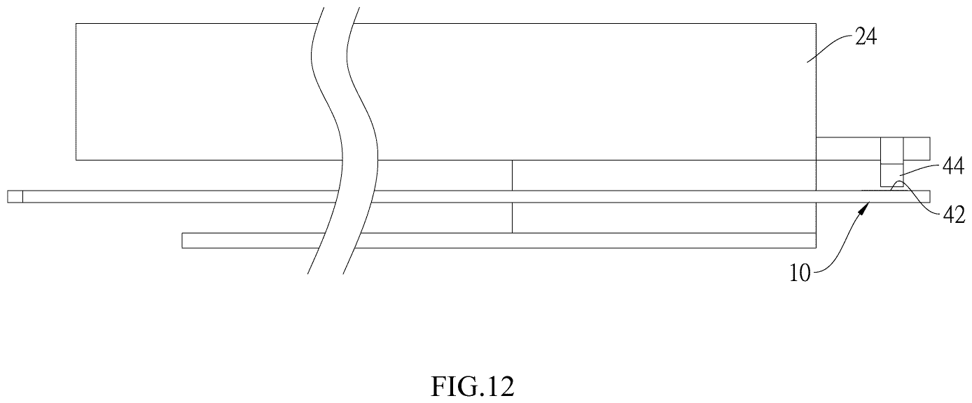

An antenna system 2 according to a second embodiment of the present invention is illustrated in FIG. 9 to FIG. 12. A structure of the antenna system 2 is almost identical to the structure of the antenna system 1 of the first embodiment, except that the antenna assembly 40 of the current embodiment is provided and the recess portion 221 is a L-shaped notch. In other words, the recess portion 221 could be disposed on a corner of the body 22.

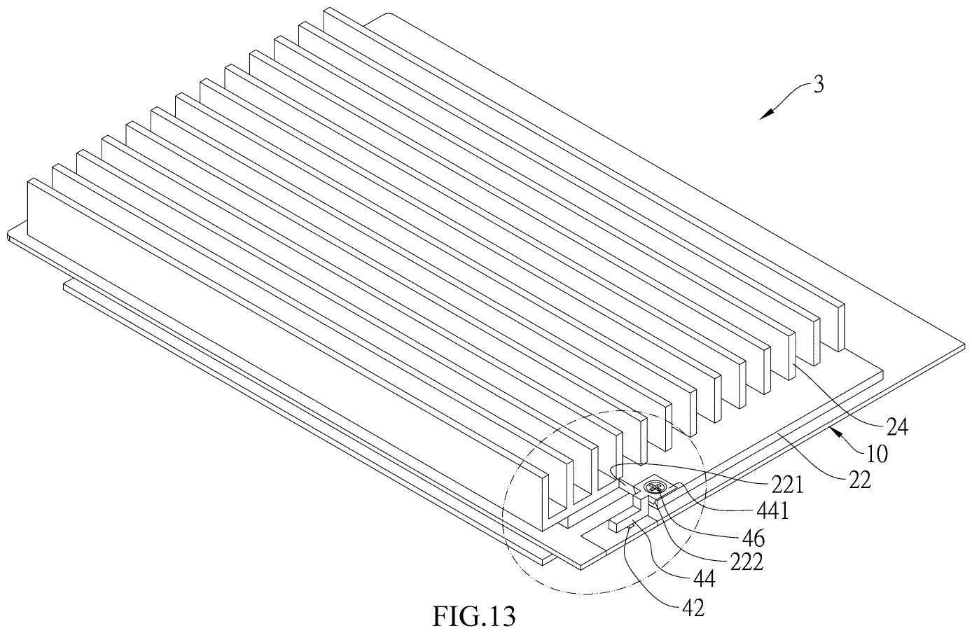

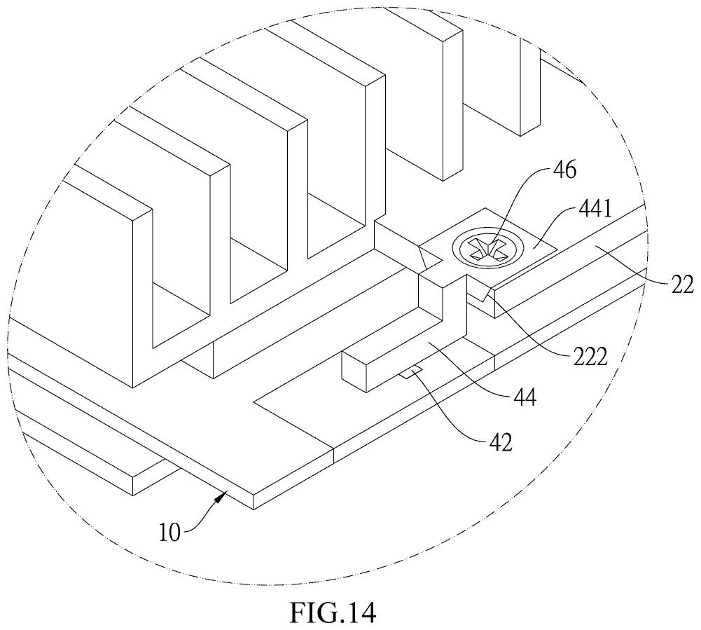

An antenna system 3 according to a third embodiment of the present invention is illustrated in FIG. 13 and FIG. 14. A structure of the antenna system 3 is almost identical to the structure of the antenna system 2 of the second embodiment, except that the body 22 of the current embodiment has a slot 222 disposed in a location adjacent to the recess portion 221 and is dented from an upper surface of the body 22. A diameter of the slot 222 is gradually decreased from a top of the slot 222 to a bottom of the slot 222. An end of the radiating section 44 connected to the body 22 has an engaging member 441 matching with the slot 222. The radiating section 44 could be engaged with the slot 222 through the engaging member 441 to be connected to the body 22. In addition, the engaging member 441 could be further fixed in the slot 222 through a fastener 46 to be firmly and closely connected to the body 22. Therefore, a problem that the metallic heat sink 20 is difficult to be soldered to the radiating section 44 could be solved.

With the aforementioned design, through the radiating section 44 disposed in the recess portion 221, a space occupied by the antenna assembly 40 could be greatly reduced and a space could be saved to be allocated to the heat dissipation structure 24, so that the heat dissipation efficiency could be greatly raised and a problem that an overall volume of a conventional antenna system is too high because of a space reserved for an antenna could be improved. In addition, through the radiating section 44 connected to the body 22, the metallic heat sink 20 could simultaneously have a heat dissipation function and an antenna communication function, so that the metallic heat sink 20 and the antenna assembly 40 could coexist without affecting each other.

It must be pointed out that the embodiments described above are only some preferred embodiments of the present invention. All equivalent structures which employ the concepts disclosed in this specification and the appended claims should fall within the scope of the present invention.

What is claimed is:

1. An antenna system, comprising:
a substrate;
a metallic heat sink disposed above the substrate and comprising a body and a heat dissipation structure, wherein the heat dissipation structure is disposed on the body; the body has a recess portion, wherein the recess portion is recessed inwards from a peripheral edge of the body; and
an antenna assembly comprising a microstrip and a radiating section, wherein the microstrip is disposed on a surface of the substrate and is coupled to a signal source; the radiating section is connected to the body and is disposed in the recess portion; an end of the radiating section is disposed in a location adjacent to the microstrip; the radiating section is excited by the microstrip using a coupling mechanism.

2. The antenna system as claimed in claim 1, wherein the recess portion has a U-shaped notch; the U-shaped notch is formed through a first lateral side, a second lateral side, and a third lateral side subsequently connected to one another; an end of the radiating section is connected to the first lateral side or the third lateral side.

3. The antenna system as claimed in claim 1, wherein the recess portion is a L-shaped notch.

4. The antenna system as claimed in claim 1, wherein the body is integrated with the radiating section.

5. The antenna system as claimed in claim 1, wherein the body has a slot disposed in a location adjacent to the recess portion; an end of the radiating section connected to the body has an engaging member matching with the slot; the radiating section is able to be engaged with the slot through the engaging member to be connected to the body.

6. The antenna system as claimed in claim 1, wherein the metallic heat sink and the radiating section are made of the identical material which is aluminum or stainless steel.

7. The antenna system as claimed in claim 1, wherein a gap is formed between the end of the radiating section adjacent to the microstrip and the microstrip.

8. The antenna system as claimed in claim 1, wherein the heat dissipation structure has a plurality of fins.

9. The antenna system as claimed in claim 1, further comprising another antenna assembly, wherein the another antenna assembly comprises another microstrip and another radiating section; the another microstrip is disposed on the surface of the substrate and is coupled to another signal source; the body has another recess portion, wherein the another recess portion is recessed inwards from the peripheral edge of the body; the another radiating section is connected to the body and is disposed in the another recess portion; an end of the another radiating section is disposed in a location adjacent to the another microstrip; the another radiating section is excited by the another microstrip using a coupling mechanism.

10. The antenna system as claimed in claim 9, wherein the body has a first side and a second side different from the first side; the recess portion is located on the first side; the another recess portion is located on the second side.
